(19) United States
(12) Patent Application Publication
(10) Pub. No.: US 2008/0086744 A1
(43) Pub. Date: Apr. 10, 2008

(54) BROADCASTING RECEIVING APPARATUS AND CONTROL METHOD THEREOF

(75) Inventors: Hyeon-seung Bae, Yeosu-si (KR); Young-joong Noh, Suwon-si (KR)

Correspondence Address: SUGHRUE MION, PLLC, 2100 PENNSYLVANIA AVENUE, N.W., SUITE 800, WASHINGTON, DC, 20037, US

(73) Assignee: Samsung Electronics Co., Ltd., Suwon-si (KR)

(21) Appl. No.: 11/858,168

(22) Filed: Sep. 20, 2007

(30) Foreign Application Priority Data
Oct. 4, 2006 (KR) 10-2006-0097642

(51) Int. Cl. G06F 3/00

(52) U.S. Cl. 725/38

(57) ABSTRACT

A broadcasting receiving method and apparatus are provided. The broadcasting receiving apparatus includes a receiver which receives a broadcasting signal; a storing part which stores a channel corresponding to the received broadcasting signal; an electric field intensity measuring part which measures an electric field intensity of the broadcasting signal corresponding to the channel; and a controller which classifies the channel into at least one channel group according to the electric field intensity and stores the classified channel group in the storing part.

### CROSS-REFERENCE TO RELATED APPLICATIONS

This application claims priority from Korean Patent Application No. 2006-0097642, filed on Oct. 4, 2006 in the Korean Intellectual Property Office, the disclosure of which is incorporated herein by reference.

### BACKGROUND OF INVENTION

1. Field of Invention

Apparatuses and methods consistent with the present invention relate to a broadcasting receiving apparatus and a control method thereof, more particularly, to a broadcasting receiving apparatus which receives a plurality of broadcasting channels and a control method thereof.

2. Description of the Related Art

Channels of broadcasting signals which users can watch when broadcasted through a broadcasting receiving apparatus, i.e., a television, are various and numerous and may range from ground wave channels to cable channels. Particularly, cable broadcasting includes different kinds of channels and services depending on local and regional areas. Thus, channel information of the same cable broadcast may varying over time.

Reception of a broadcasting signal, i.e., an electric field intensity of broadcasting signal, is different for each channel. However, if a channel is searched using an automatic channel search, all channels are tuned and saved regardless of the channels current reception, and thus, a user may not be able to select a specific channel unless it has been previously tuned and saved.

Additionally, because it is not easy to adjust a channel, the user may receive an undesired and unnecessary channel, such as a channel with low reception, a scramble signal, or the like.

### SUMMARY OF THE INVENTION

Exemplary embodiments of the present invention overcome the above disadvantages and other disadvantages not described above. Also, the present invention is not required to overcome the disadvantages described above, and an exemplary embodiment of the present invention may not overcome any of the problems described above. Accordingly, it is an aspect of the present invention to provide a broadcasting receiving apparatus and a control method thereof where a user may easily select a broadcasting channel.

Additional aspects of the present invention will be set forth in part in the description which follows and, in part, will be obvious from the description, or may be learned by practice of the present invention.

The foregoing and/or other aspects of the present invention can be achieved by providing a broadcasting receiving apparatus comprising: a receiver which receives a broadcasting signal; a storing part which stores a channel corresponding to the received broadcasting signal; an electric field intensity measuring part which measures an electric field intensity of the broadcasting signal corresponding to the channel; and a controller which classifies the channel into at least one channel group according to the electric field intensity and stores the classified channel group in the storing part.

According to an aspect of the invention, the controller determines whether the received broadcasting signal is a scramble signal, and stores the channel corresponding to the scramble signal in a scramble channel group in the storing part if the received broadcasting signal is the scramble signal.

According to another aspect of the invention, the controller classified the channel in to the channel group by comparing the measured electrical field intensity to a threshold value.

According to another aspect of the invention, the at least one channel group includes a high reception channel group and a low reception channel group and the controller classifies the channel as a channel of the high reception channel group in response to the electrical field intensity exceeding a threshold value and classifies the channel as a channel of the low reception group in response to the electrical field intensity being below the threshold value.

According to an aspect of the invention, the broadcasting receiving apparatus further comprises a user input part which selects at least one channel group based on a user's input; and a user interface generating part which generates a channel group selection menu to select the at least one channel group.

According to an aspect of the invention, the channel group selection menu comprises a main menu which comprises the at least one channel group and the channel corresponding to the at least one channel group.

According to an aspect of the invention, the user interface generating part generates a sub menu which comprises detailed information related to a selected channel group from the at least one channel group, a selection icon to select the selected channel group and a deletion icon to delete the selected channel group if one channel group is selected through the user input part.

According to an aspect of the invention, the channel group comprises at least one of a high reception channel group, a scramble channel group and a low reception channel group.

According to an aspect of the invention, the controller deletes the selected channel group and the channel of the selected channel group if the delete icon is selected.

According to an aspect of the invention, the controller stores the selected channel group and the channel of the selected channel group in the storing part and controls the receiver to receive the stored channel if the select icon is selected.

The foregoing and/or other aspects of the present invention can be achieved by providing a broadcasting receiving apparatus comprising: a receiver which receives a broadcasting signal; an electric field intensity measuring part which measures an electric field intensity of the received broadcasting signal; a storing part which stores a channel corresponding to the broadcasting signal in at least one channel group according to the electric field intensity of the broadcasting signal; a user input part which selects at least one channel group; a user interface generating part; and a controller which determines whether the received broadcasting signal is a scramble signal and, if the broadcasting signal is the scramble signal, stores the scramble signal in a scramble channel group in the storing part and controls the user interface generating part to generate a channel group selection menu to select at least one channel group if a channel selection function to select the at least one channel group is selected through the user input part.

According to an aspect of the invention, the channel group selection menu comprises a main menu which comprises the at least one channel group and the channel of the at least one channel group and a sub menu which comprises detailed information related to the selected channel group of the at least one channel group of the main menu, a selection icon to select the selected channel group and a deletion icon to delete the selected channel group.

According to an aspect of the invention, the controller deletes the selected channel group and a plurality of channels of the selected channel group if the deletion icon is selected.

According to an aspect of the invention, the controller controls the receiver to receive a plurality of channels of the selected channel group if the selection icon is selected.

The foregoing and/or other aspects of the present invention can be achieved by providing a control method of a broadcasting receiving apparatus comprising: receiving a broadcasting signal and storing a channel corresponding to the broadcasting signal; determining whether the broadcasting signal corresponding to the channel is a scramble signal; storing the channel corresponding to the scramble signal to a scramble channel group if the broadcasting signal is the scramble signal; and generating a channel group selection menu to select or delete the scramble channel group.

According to an aspect of the invention, the control method of the broadcasting receiving apparatus further comprises measuring an electric field intensity of the broadcasting signal if the broadcasting signal is not the scramble signal; and classifying the channel of the broadcasting signal into at least one channel reception group according to the electric field intensity, wherein the channel group selection menu further comprises a selection menu to select or delete the channel reception group.

According to an aspect of the invention, the control method of the broadcasting receiving apparatus further comprises deleting the channel of a deleted group if at least one of the scramble channel group and the channel reception group is deleted.

According to an aspect of the invention, the control method of the broadcasting receiving apparatus further comprises storing the channel if at least one of the scramble channel group and the channel reception group is selected; and receiving the stored channel.

### BRIEF DESCRIPTION OF THE DRAWINGS

The above and/or other aspects of the present invention will become apparent and more readily appreciated from the following description of the exemplary embodiments, taken in conjunction with the accompanying drawings, in which:

FIG. 1 is a control block diagram of a broadcasting receiving apparatus according to an exemplary embodiment of the present invention.

FIG. 2 is a storing part of the broadcasting receiving apparatus according to the exemplary embodiment of the present invention.

FIGS. 3, 4, 5A and 5B illustrate a user interface screen of the broadcasting receiving apparatus according to the exemplary embodiment of the present invention.

FIG. 6 is a flow chart to illustrate a control method of the broadcasting receiving apparatus according to the exemplary embodiment of the present invention.

### DETAILED DESCRIPTION OF EXEMPLARY EMBODIMENTS OF THE INVENTION

Reference will now be made in detail to the exemplary embodiments of the present invention, examples of which are illustrated in the accompanying drawings, wherein like reference numerals refer to like elements throughout. The exemplary embodiments are described below so as to explain the present invention by referring to the figures.

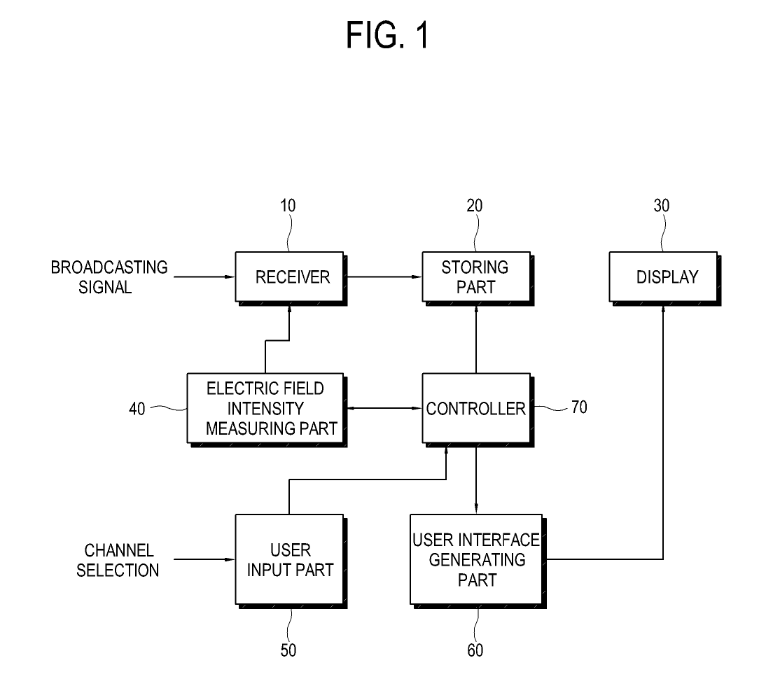

Referring to FIG. 1, a broadcasting receiving apparatus according to an exemplary embodiment of the present invention includes a television, in particular a cable television to receive cable broadcasting, which receives various broadcasting signals output from a broadcasting station to display them. The broadcasting receiving apparatus includes a receiver 10, a storing part 20, a display 30, an electric field intensity measuring part 40, a user input part 50, a user interface generating part 60 and a controller 70 which controls these components.

The receiver 10 receives broadcasting signals which a broadcasting station transmits. The receiver 10 includes an antenna (not shown), a tuner which tunes a broadcasting signal corresponding to a specific frequency, a frequency of a desired channel, to a predetermined frequency, and a low noise amplifier which amplifies the broadcasting signal inputted to the tuner.

The storing part 20 stores a channel corresponding to a received broadcasting signal. The channel represents a frequency or a frequency band which may be allocated to a broadcasting station. Generally, channel information on a specific frequency and a broadcasting signal corresponding to a correspondent channel are received by a broadcasting receiving apparatus at the same time, but the received broadcasting signal may be numbered sequentially to be recognized as a channel. However, recognizing a particular process of identifying the channels within the broadcast signal does not matter, as long as the storing part 20 stores distinctive information on a channel corresponding to a broadcasting signal, i.e., a channel number. Hereinafter, a channel indicates a channel number to distinguish a plurality of channels which represent frequency bands.

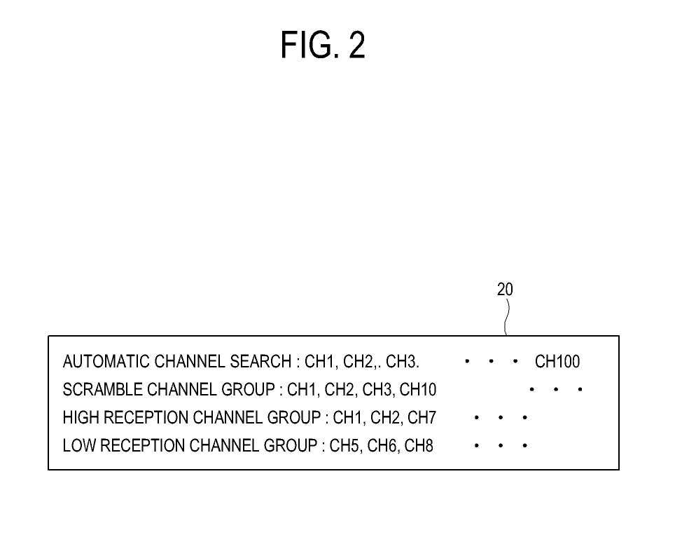

Referring to FIG. 2, the storing part 20 according to the exemplary embodiment stores a plurality of channels which are tuned in the tuner. If a user performs automatic channel search, the storing part 20 stores all broadcasting signals, which the broadcasting receiving apparatus receives, by channel. If the broadcasting receiving apparatus is a cable television, a large number of channels may be searched and stored in the storing part 20. These broadcasting signals of received channels are classified into a plurality of groups by the controller 70 and stored in the storing part 20. The broadcasting signals may include a high reception signal, where an electric field intensity is strong enough to be displayed on the broadcasting receiving apparatus without difficulty, a low reception signal, which is received to the receiver 10 but not displayed in the broadcasting receiving apparatus due to having a weak electric field intensity, and a scramble signal, which is specifically coded by a broadcasting station so that it is difficult to display without descrambling.

The display 30 displays the broadcasting signals received by the receiver 10. The display 30 may include a cathode ray tube (CRT), an organic light emitting diode (OLED) panel, a plasma display panel (PDP), etc. Further, the display 30 displays a channel group selection menu generated in the user interface generating part 60 so that the user may select or delete a channel group.

The electric field measuring part 40 measures an electric field intensity of a broadcasting signal corresponding to a channel. If channels are searched according to automatic channel search, broadcasting signals of which minimum electric field intensities are more than a threshold value, for example, about 20 dB, are tuned and stored in the storing part 20. Then, the electric field intensities of the broadcasting signals of the channels are measured by the electric field intensity measuring part 40.

The user input part 50 generates a control signal to select one of channel groups and outputs various control signals according to a user's operation. The user input part 50 may include an additional shortcut key for a channel group selection function to select a channel group. The user input part 50 may include a remote controller which communicates with the broadcasting receiving apparatus from a remote place or a button, a touch pad, etc. which are provided externally, such as on an outside frame of the broadcasting receiving apparatus.

The user interface generating part 60 generates the channel group selection menu to select a channel group according to control of the user input part 50 and the controller 70 and displays it on the display 30. The channel group selection menu includes a main menu to display a plurality of channel groups stored in the storing part 20 and a sub menu to separately select or delete the respective channel groups. The main menu and the sub menu may comprise various shapes and configurations, which will be mentioned later.

The controller 70 divides channels into at least one channel group according to the electric field intensity and stores them in the storing part 20. The controller 70 controls the user interface generating part 60 to generate the channel group selection menu so that the user may select or delete the channel group.

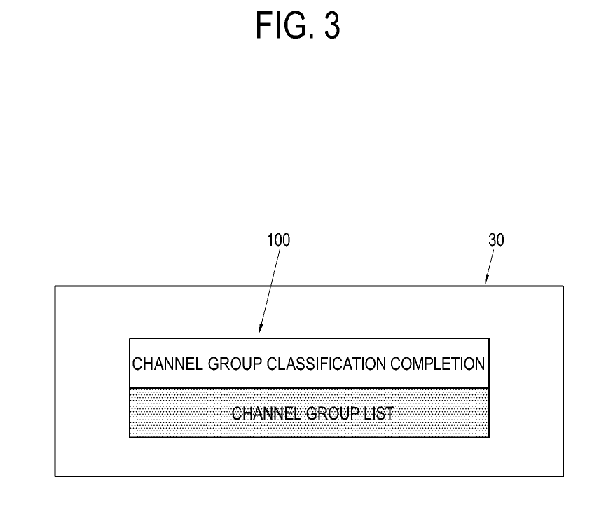

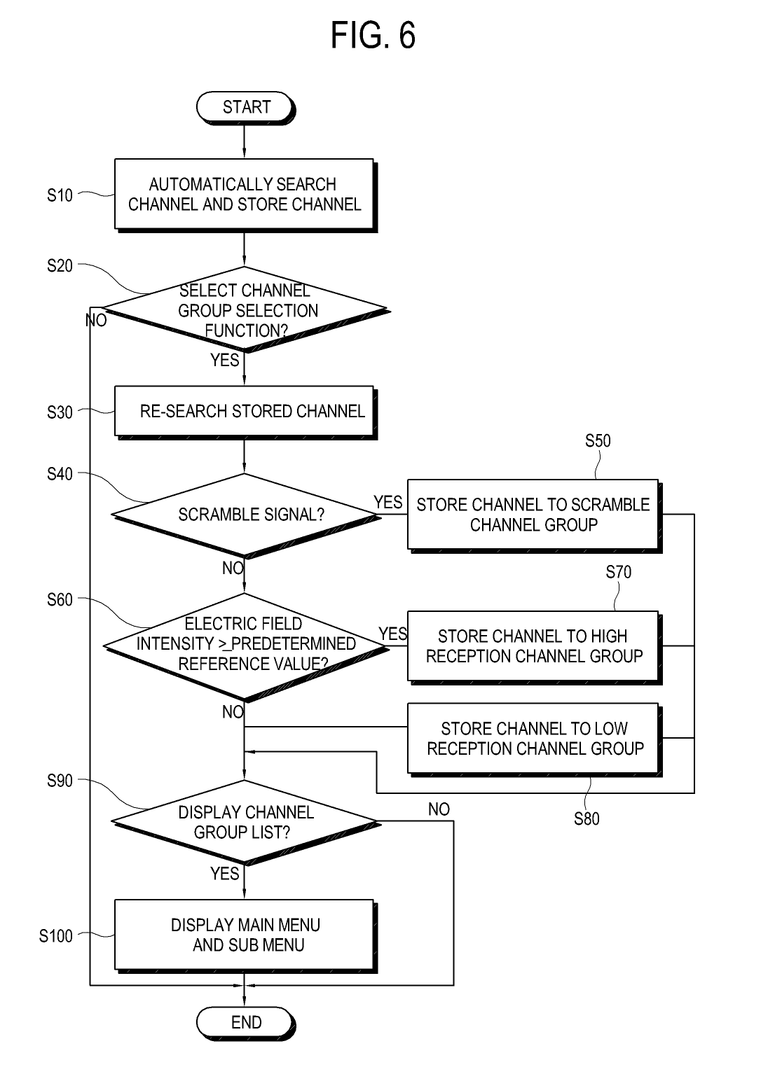

Hereinafter, a control process by the controller 70 according to the exemplary embodiment of the present invention will be described with reference to FIGS. 3 through 6. FIGS. 3 through 5B illustrate a user interface screen of the broadcasting receiving apparatus according to the exemplary embodiment of the present invention. FIG. 6 is a flow chart to illustrate a control method of the broadcasting receiving apparatus according to the exemplary embodiment of the present invention.

Referring to FIG. 6, if an automatic channel search function is selected through the user input part 50, the tuner in the receiver 10 tunes a received broadcasting signal, and the storing part 20 stores a channel of the tuned broadcasting signal (S10). All channels with minimum electric field intensities are stored in the storing part 20 by the automatic channel search, as shown in FIG. 2.

Then, if the channel group selection function is selected through the user input part 50 (S20), the controller 70 controls the receiver 10 and the electric field intensity measuring part 40 to re-search, i.e., re-tune, the stored channels and to measure electric field intensities of broadcasting signals corresponding to the respective channels (S30).

The controller 70 determines whether the received broadcasting signal is a scramble signal (S40). A scramble signal refers to an encrypted signal by adding a special signal or changing an order of scanning lines and is used for paid channel broadcasting such as satellite broadcasting, cable television, etc. so that only an authorized user may watch it. A broadcasting station scrambles broadcasting signals according to rules and transmits them to prevent unauthorized reception of the scramble signal. The scramble signal is not displayed normally on an ordinary television. The scramble signal may be decoded using a decoder so that the scramble signal can be displayed normally.

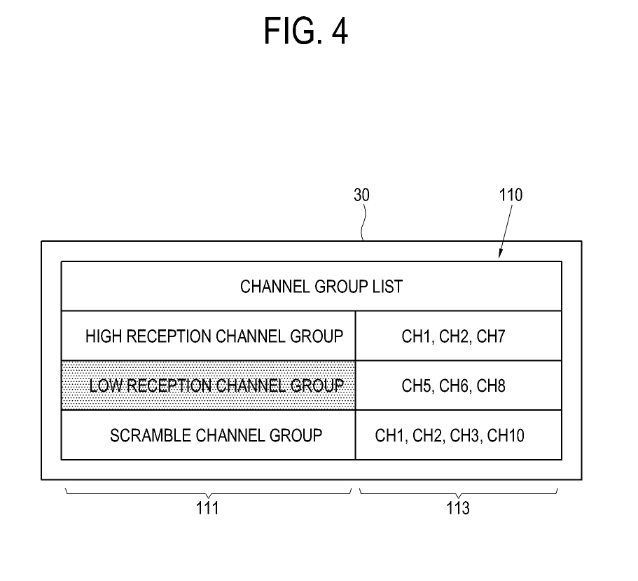

If the broadcasting signals are scramble signals, the storing part 20 stores channels corresponding to the scramble signals in a scramble channel group (S50), shown in FIG. 4. If a scramble signal is not received, no channel is stored in the scramble channel group. The controller 70 may further include an additional signal determining part to determine whether a received broadcasting signal is a scramble signal.

Then, the controller 70 compares the electric field intensities of the broadcasting signals, which are not scramble signals, with a predetermined reference or threshold value (S60). If the predetermined reference value is, for example, 50 dB, the storing part 20 stores a channel of a broadcasting signal with an electric field intensity of more than 50 dB in a high reception channel group (S70) and another channel with electric field intensity of less than 50 dB in a low reception channel group (S80). The high reception channel group is a group of channels of broadcasting signals which have enough electric field intensity for the user to see a clear screen without difficulties. On the other hand, the low reception channel group is a group of channels of broadcasting signals which have weak electric field intensity that may result in a poor image quality. The aforementioned reference value is just an example and may be modified variously. A reference value may be set at 60 dB, or a plurality of reference values may be provided as a reference value on a high reception channel group and another reference value on a low reception channel group.

To sum up, a control signal on the channel group selection function is selected through the user input part 50, the controller 70 classifies the received broadcasting signals into channel groups and stores them in the storing part 20, shown in FIG. 2.

Referring to FIG. 3, the controller 70 controls the user interface generating part 60 to display a channel group classification completion window 100 on the display 30. The channel group classification completion window 100 displays a message to represent that the channel groups are completely classified, i.e., “Channel group classification completion”, and a message to represent a channel group list, i.e., “Channel group list”. As illustrated in FIG. 3, the “Channel group list” is activated to be selected by the user. Namely, if the “Channel group list” is selected by the user (S90), the user interface generating part 60 displays a main menu 110 to represent a channel group list on the display 30 (S100), shown in FIG. 4.

Alternatively, the controller 70 directly displays the main menu 110 without displaying the channel group classification completion window 100. In other words, if the channel group selection function is selected through the user input part 50, the controller 70 may interpret the selection as a control signal for channel group classification and channel group list display to select a channel group.

The main menu 110 includes a plurality of channel groups 111, such as a high reception channel group, a low reception channel group and a scramble channel group, and channels 113 which are included in each channel group 111. The user may move a cursor among the channel groups 111 through the user input part 50. If the cursor stays on one channel group 111, the channel group 111 is activated as a mark that the channel group 111 may be selected.

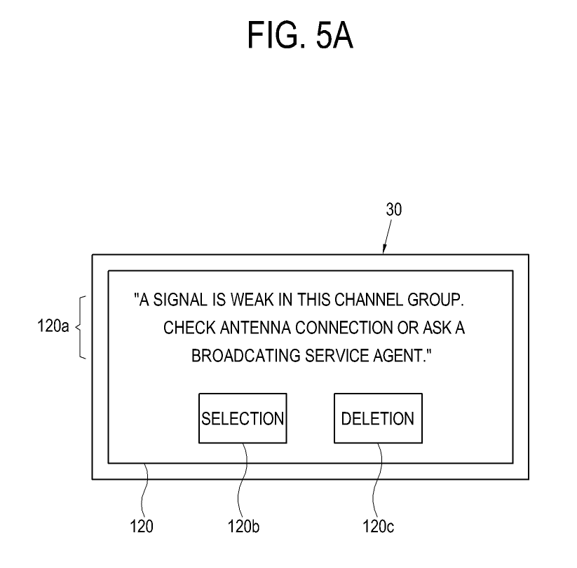

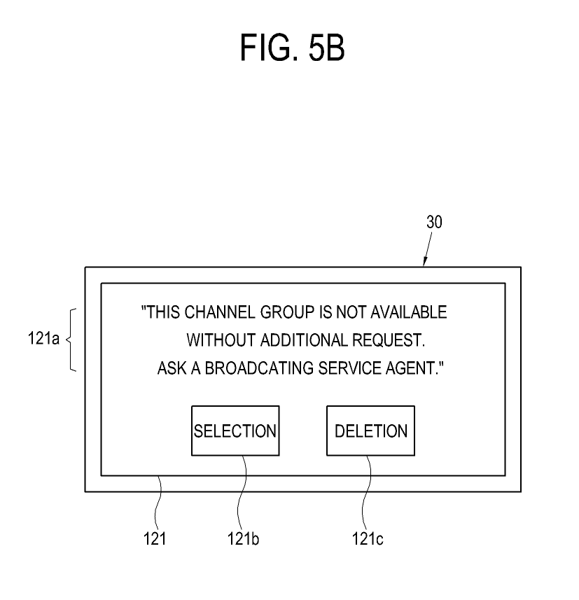

If one of the channel groups 111 is selected, the sub menu 120 and 121 is displayed on the display 30 as shown in FIGS. 5A and 5B. The sub menu 120 and 121 includes detailed information 120a and 121a on the selected channel group 111, a selection icon 120b and 121b to select the selected channel group 111 and a deletion icon 120c and 121c to delete the selected channel group 111.

FIG. 5A shows the sub menu 120 if the low reception channel group 111 is selected. If the user selects or deletes a channel group, the detailed information 120a displays that “In this channel group, a signal is weak. Check antenna connection or ask a broadcasting service agent.” to help the user's determination. The user may delete the low reception channel group in response to the detailed information 120a directly or after checking the antenna connection. If the deletion icon 120b is selected, the controller 70 deletes a selected channel group and a channel in the selected channel group out of the channel groups in the storing part 20. Then, the receiver 10 does not receive a broadcasting signal corresponding to the deleted channel. If the selection icon 120c is selected, however, the controller 70 stores the selected channel in the storing part 20 and controls the receiver 10 to receive a broadcasting signal corresponding to the stored channel.

FIG. 5B shows the sub menu 121 if the scramble channel group 111 is selected. The detailed information 121a displays that “This channel group is not available without additional request. Ask a broadcasting service agent.” The user may delete the scramble channel group 111 so as not to receive a scramble signal, or select the channel group 111 and ask a correspondent broadcasting service agent to be provided with service.

If the user deletes all channel groups 111, he/she may store all channels received by the automatic channel search function.

In conclusion, the exemplary embodiments of the present invention provide the user interface to select and delete the broadcasting signals and the correspondent channels, and thus the user may select desired channel without difficulties.

As described above, the exemplary embodiments of the present invention provide a broadcasting receiving apparatus and a control method thereof where a user may easily select a broadcasting channel.

Although a few exemplary embodiments of the present invention have been shown and described, it will be appreciated by those skilled in the art that changes may be made in these embodiments without departing from the principles and spirit of the invention, the scope of which is defined in the appended claims and their equivalents.

What is claimed is:

1. A broadcasting receiving apparatus comprising:
a receiver which receives a broadcasting signal;
a storing part which stores a channel corresponding to the received broadcasting signal;
an electric field intensity measuring part which measures an electric field intensity of the broadcasting signal corresponding to the channel; and
a controller which classifies the channel into at least one channel group according to the electric field intensity and stores the classified channel group in the storing part.

2. The broadcasting receiving apparatus according to claim 1, wherein the controller determines whether the received broadcasting signal is a scramble signal, and stores the channel corresponding to the scramble signal in a scramble channel group in the storing part if the received broadcasting signal is the scramble signal.

3. The broadcasting receiving apparatus according to claim 1, wherein the controller classifies the channel into the channel group by comparing the measured electrical field intensity to a threshold value.

4. The broadcasting receiving apparatus according to claim 3, wherein the at least one channel group includes a high reception channel group and a low reception channel group,
wherein the controller classifies the channel as a channel of the high reception channel group in response to the electrical field intensity exceeding a threshold value and classifies the channel as a channel of the low reception group in response to the electrical field intensity being below the threshold value.

5. The broadcasting receiving apparatus according to claim 2, further comprising:
a user input part which selects the at least one channel group based on a user's input; and
a user interface generating part which generates a channel group selection menu to select the at least one channel group.

6. The broadcasting receiving apparatus according to claim 5, wherein the channel group selection menu comprises a main menu which comprises the at least one channel group and the channel corresponding to the at least one channel group.

7. The broadcasting receiving apparatus according to claim 6, wherein the user interface generating part generates a sub menu which comprises detailed information related to the selected at least one channel group, a selection icon to select the selected at least one channel group and a deletion icon to delete the selected at least one channel group, if one channel group is selected through the user input part.

8. The broadcasting receiving apparatus according to claim 6 wherein the at least one channel group comprises at least one of a high reception channel group, a scramble channel group and a low reception channel group.

9. The broadcasting receiving apparatus according to claim 7, wherein the channel group comprises at least one of a high reception channel group, a scramble channel group and a low reception channel group.

10. The broadcasting receiving apparatus according to claim 7, wherein the controller deletes the selected at least one channel group and the channel of the selected at least one channel group if the deletion icon is selected.

11. The broadcasting receiving apparatus according to claim 7 wherein the controller stores the selected at least one channel group and the channel corresponding to the selected at least one channel group in the storing part and controls the receiver to receive the stored channel if the selection icon is selected.

12. A broadcasting receiving apparatus comprising:
a receiver which receives a broadcasting signal;
an electric field intensity measuring part which measures an electric field intensity of the received broadcasting signal;
a storing part which stores a channel corresponding to the broadcasting signal in at least one channel group according to the electric field intensity of the broadcasting signal;
a user input part which selects at least one channel group;
a user interface generating part; and
a controller which determines whether the received broadcasting signal is a scramble signal and, if the broadcasting signal is the scramble signal, stores the scramble signal in a scramble channel group in the storing part and controls the user interface generating part to generate a channel group selection menu to select at least one channel group if a channel selection function to select the at least one channel group, is selected through the user input part.

13. The broadcasting receiving apparatus according to claim 10, wherein the channel group selection menu comprises a main menu which comprises the at least one channel group and the channel of the at least one channel group and a sub menu which comprises detailed information related to the selected at least one channel group, a selection icon to select the selected channel group and a deletion icon to delete the selected channel group.

14. The broadcasting receiving apparatus according to claim 13, wherein the controller deletes the selected at least one channel group and a plurality of channels of the selected at least one channel group if the deletion icon is selected.

15. The broadcasting receiving apparatus according to claim 13, wherein the controller controls the receiver to receive a plurality of channels of the selected at least one channel group if the selection icon is selected.

16. A control method of a broadcasting receiving apparatus comprising:
receiving a broadcasting signal and storing a channel corresponding to the broadcasting signal;
determining whether the broadcasting signal corresponding to the channel is a scramble signal;
storing the channel corresponding to the scramble signal to a scramble channel group if the broadcasting signal is the scramble signal; and
generating a channel group selection menu to select or delete the scramble channel group.

17. The control method of the broadcasting receiving apparatus according to claim 16, further comprising:
measuring an electric field intensity of the broadcasting signal if the broadcasting signal is not the scramble signal; and
classifying the channel of the broadcasting signal into at least one channel reception group according to the electric field intensity,
wherein the channel group selection menu further comprises a selection menu to select or delete the at least one channel reception group.

18. The control method of the broadcasting receiving apparatus according to claim 17, further comprising deleting the channel if at least one of the scramble channel group and the channel reception group is deleted.

19. The control method of the broadcasting receiving apparatus according to claim 17, further comprising
storing the channel if at least one of the scramble channel group and the channel reception group is selected; and
receiving the stored channel.
